(19) United States
(12) Patent Application Publication
(10) Pub. No.: US 2025/0379848 A1
(43) Pub. Date: Dec. 11, 2025

(54) METHOD FOR COMMUNICATION BETWEEN TWO DEVICES, FIRST DEVICE, SECOND DEVICE AND CORRESPONDING COMPUTER PROGRAM

(71) Applicant: ORANGE, Issy-les-Moulineaux (FR)

(72) Inventors: Mohamed Boucadair, Châtillon (FR); Christian Jacquenet, Châtillon (FR)

(21) Appl. No.: 18/874,305

(22) PCT Filed: Jun. 15, 2023
(86) PCT No.: PCT/EP2023/066054

§ 371 Date: Dec. 12, 2024

(30) Foreign Application Priority Data
Jun. 16, 2022 (FR) FR2205880

(51) Int. Cl. H04L 61/5038; H04L 9/40; H04L 101/622

(52) U.S. Cl. CPC H04L 61/5038; H04L 63/0414; H04L 63/0428; H04L 2101/622

(57) ABSTRACT

A method for communication between a first device and a second device, implemented by the first device. The method includes: establishing a first secure connection between the first device and the second device, via a first communication interface of the first device; transmitting, using the first secure connection, a message including at least one encrypted MAC address, associated or capable of being associated with the first interface and used to communicate with or via the second device or an intermediate device located on a communication path between the first device and the second device.

### 1. FIELD OF THE INVENTION

The field of the invention is that of communications within at least one communication network, for example a computer network implementing the IP protocol.

More specifically, the invention relates to the management of at least one MAC (Media Access Control) address assigned to at least one interface of a device connected to a communication network.

The invention proposes in particular a solution for providing a continuity of service in case of MAC address renewal.

### 2. PRIOR ART

MAC addresses are identifiers assigned to network interfaces for communication purposes. These identifiers are generally assigned by the manufacturers of the network adapters. A MAC address is often considered to be unique and permanent (that is it does not change over time), making it possible to track and identify a device such as a terminal, even when it is in motion. As a result, a network access device (for example, a router or a CPE (Customer Premises Equipment), etc.) can dynamically acquire the MAC address of another device connected to the network or declare this MAC address to said access device. It is also possible to configure the network access device to filter certain declared or dynamically acquired MAC addresses, for example to authorise incoming or outgoing traffic only for declared or trusted devices.

However, the dynamic acquisition or the declaration of MAC addresses is based on messages exchanged on the network to which said other device and said access device are connected. These messages are not encrypted, so MAC addresses can be hacked and used to track a device, and in particular to determine its location. This may adversely affect the confidentiality of the data exchanged by users of such devices or of the characteristic data of these users.

More and more devices (machines, operating systems, etc.) now use a procedure of random generation (or “randomisation”) of MAC addresses, that is these devices use random MAC addresses to communicate with other devices connected to the same network (for example, local area network, public hotspots) or to a separate network, which in particular helps to preserve the confidentiality of the data exchanged by users or of the characteristic data of the users.

An incorrect configuration of a MAC address generation mode can have a negative impact on the stability of the services offered in certain networks. Indeed, a number of services rely on MAC addresses to identify devices and apply certain policies, such as rules for accessing services, prioritisation of the access to local resources (printers, for example), rules for mitigating Distributed Denial of Service (DDOS) attacks, parental control, allocation of fixed IP addresses, etc., or for requesting the approval of an administrator when a new device connects to the network. The use of random MAC addresses can then lead to the filtering or rejection of the traffic from a device that is normally authorised by an access device (for example, a CPE), because it has not recognised the MAC address assigned to the device. The use of random MAC addresses can therefore prevent a “legitimate” device, authorised to communicate by the access device, from accessing local or remote services (Internet, etc.), which is detrimental to the customer experience.

Solutions based on the use of IP addresses (IPv4 or IPv6) have also been proposed in the context of DDOS attacks for identification and mitigation purposes. For example, when a DDOS attack is detected (either through a report from a victim or a third-party operator, or through local detection by the connectivity provider, for example), the access network seeks to isolate the source(s) of the attack (i.e. the local area network from which the attack originates). To do this, filters based in particular on the IPv4 address or IPv6 prefix allocated to the access device (for example, the CPE) that connects said local area network and the access network can be set up in one of the access devices.

However, filtering based on an IPV4 address is not optimal, because the IPv4 address undergoing such a filtering is generally used to transmit traffic sent by, or destined for, all the devices connected to the access device, which makes it difficult, if not impossible, to identify the device at the origin of the attack using this shared IPv4 address alone. In other words, if the various devices connected to the access device via the local area network share the same IPv4 address, the access device will filter the traffic from or to said devices, and it will not be possible to identify the malicious device precisely among the various devices connected to the access device via the local area network.

Such filters also have the disadvantage of affecting access to the various services by legitimate devices connected to the same access device (and therefore not involved in the attack). Then, on the one hand, the customer is the victim of a malicious entity that uses some of the devices connected to its local area network to relay the attack traffic (for example, an IP camera or any other connected object), and on the other hand, he suffers a significant deterioration in the quality or even the unavailability of the services to which he has subscribed as soon as such filters are activated by the operator of the access network. Such a degradation can in particular be caused by a rate-limiting procedure implemented by one or more devices of the network of the access operator.

It should also be noted that maintaining and applying filters based on a list of authorised or unauthorised addresses (commonly known as an access control list or ACL) by a router very often degrades its performance, since such a router has to scan all the entries in these lists before deciding to forward (or not) a received packet. Filtering based on an IPv6 address or prefix is not more effective, because a malicious device can generate new IPv6 addresses (2⁶⁴ available addresses) and thus evade the filtering rules set up by an access network. The application of filtering rules based on IPv6 addresses or prefixes can thus be diverted from its initial objective to generate a DDoS attack against the router that maintains said filtering list. Indeed, a malicious device can generate a large number of IPv6 addresses at a high frequency in order to quickly reach the maximum packet processing capacity of an access device, so that it becomes inoperative.

In order to overcome such limitations, a solution has been documented in document RFC 9066 (“Distributed Denial-of-Service Open Threat Signaling (DOTS) Signal Channel Call Home”) dated December 2021, to signal the access device, typically a CPE, that a device of the local area network is transmitting/relaying attack traffic. This signalling comprises several items of information such as the source address, the source port number, the protocol, etc. This information is used by the access device to identify (for example, by consulting its ARP (Address Resolution Protocol) table) the internal IP address (for example, the private IPv4 address) assigned to the malicious device (or exploited for malicious purposes) and that corresponds to the information thus reported. The access device then configures filters based on the MAC address of the device thus identified to control access to services (incoming traffic, outgoing traffic, etc.). This control typically consists in restricting the access of said device to the network.

However, such a solution is difficult to implement in case the MAC address is renewed. There is therefore a need for a solution providing for example a continuity of service in case of MAC address renewal.

### 3. SUMMARY OF THE INVENTION

The invention proposes a solution in the form of a method for communication between a first device and a second device.

According to the invention, the first device implements the following steps:
establishing a first secure connection between the first device and the second device, via a first communication interface of the first device,
transmitting, using the first secure connection, a message including at least one encrypted MAC address, associated or capable of being associated with the first interface and used to communicate with or via the second device or an intermediate device located on a communication path between the first device and the second device.

Thus, according to this embodiment of the invention, the first device can declare to the second device the current MAC address it uses to communicate with or via the second device, or at least one candidate MAC address it wants to use to communicate with or via the second device. Encrypting at least one MAC address increases the confidentiality of the item of information transmitted. In addition, this embodiment allows this/these MAC address(es) to be communicated to the second device when it is not directly connected to the first device (in the case of a hierarchical network, for example). Finally, it is possible for a device receiving said message to compare the source MAC address of the message (which can be carried in clear text in the message header) with the encrypted MAC address as declared in the message, in order to detect any fraudulent manipulation of MAC addresses.

The proposed solution thus helps, according to at least one embodiment, to preserve the confidentiality of communications.

For example, the first secure connection is based on a secure transport protocol, such as the QUIC protocol, or on a secure application protocol such as the CoAP (Constrained Application Protocol) over DTLS (Datagram Transport Layer Security) protocol, or the PCP (Port Control Protocol) protocol, and so on. The proposed solution thus offers the advantage of using functions supported by a secure protocol, rather than simply relying on the use of MAC addresses. The use of a secure channel and the encryption of MAC addresses help in particular to obtain an authorisation to access the network based on the MAC address, even if the access control is activated by a device that is not on the same link (that is, located several IP hops away).

Thus, the message corresponds for example to at least one frame belonging to the group comprising:
a frame describing the current MAC address that the first device uses to communicate with or via the second device, for example a QUIC frame referred to herein as “CURRENT_MAC_ADDRESS”,
a frame describing a candidate MAC address that the first device plans to use to communicate with or via the second device, for example a QUIC frame referred to herein as “CANDIDATE_MAC_ADDRESS”,
a frame describing a list of MAC addresses that the first device plans to use to communicate with or via the second device, for example a QUIC frame referred to herein as “LIST_MAC_ADDRESS”.

In a particular embodiment, the proposed solution provides a continuity of service, even in case of MAC address renewal. The proposed solution is referred to as MUSC (Efficient MAC address Update for Service Continuity) in the remainder of this document.

The first device and the second device can be connected to the same network, for example a local area network, such as a home network or a company intranet, or to separate networks. Such a network can possibly be a hierarchical network, that is a network in which one or more IP routers have been deployed. IP connectivity can be provided via a wired network, a wireless network (e.g. 5G), or both.

For example, the first device is a terminal (fixed or mobile, such as a computer, a smartphone, etc.) and the second device is an access device such as a CPE, a hotspot, an STB (set-top box), a router, a gateway, etc. Such an access device can be used, for example, to connect a device to a local area network, particularly in the case of a CPE. As a variant, such an access device can be used to connect a device of a local area network to an external network, particularly in the case of an access router.

The first interface of the first device is, for example, a WLAN (Wireless LAN) interface, an Ethernet interface, etc. The intermediate device can be another router located on the path between the first device and the second device. No assumptions are made as to the nature of the devices involved or the architecture of the network(s). Similarly, no assumptions are made as to the nature of the service(s) set up based on the MAC addresses.

In particular, the proposed solution does not require any explicit authentication or the establishment of a security association between the first device (terminal, for example) and the second device (CPE, for example) for each exchange of packets with devices external to the network.

According to a particular embodiment, said at least one MAC address comprises a current MAC address associated with the first interface and used to communicate with or via the second device or the intermediate device, and the first device implements the reception, using the first secure connection, of a message verifying the absence of conflict in the use of the current MAC address.

In this case, the first device can generate a (new) MAC address, assign it to the first interface and then the second device can verify the absence of conflict in the use of this current MAC address. If a conflict is detected, the second device can transmit to the first device a request to renew the current MAC address.

According to another particular embodiment, said at least one MAC address comprises at least one candidate MAC address capable of being associated with the first interface and used to communicate with or via the second device or the intermediate device, and the first device implements the reception, using the first secure connection, of a message verifying the absence of conflict in the use of at least one of the candidate MAC addresses, and in the absence of conflict, the association of the first interface with a verified candidate MAC address.

In this case, the first device can generate at least one candidate MAC address, the second device can verify the absence of conflict in the use of this or these candidate MAC address(es), and then assign one of the verified candidate MAC addresses (i.e. with no use conflict) to the first interface. If a conflict is detected, the second device can transmit to the first device a request to renew the concerned candidate MAC address(es).

In a particular embodiment, the method implemented by the first device comprises receiving, using the first secure connection, a security key generated by the second device.

Such a key can be used permanently or renewed dynamically, possibly on a regular basis. Such a key can thus be generated randomly, periodically or following a triggering event. In this way, the first device can use this key to transmit the encrypted message comprising at least one MAC address associated or capable of being associated with the first interface, which improves the security of the exchanges and possibly detects any spoofing of the first device.

For example, when the QUIC protocol is used for the first secure connection, such a key can be received in a QUIC frame, referred to as MAC_TOKEN for example.

In a particular embodiment, a temporary IP address is allocated to the first device for transmitting the message, and the method implements an allocation of a new IP address to the first device after validation, by the second device, of said at least one MAC address.

In particular, such a temporary IP address can be used to establish a communication with the second device, but not with the other devices of the network. Only once said at least one MAC address has been validated by the second device (i.e. in the absence of conflict in the use of said at least one MAC address and if any security context has been verified) can the temporary IP address be reconfigured into a permanent IP address, and used by the first device to communicate with the other devices of the network or of external networks. This temporary address is used to check more generally whether the first device is authorised to connect to the network.

This approach has the advantage of ensuring the confidentiality of communications, by using a temporary IP address for the exchanges related to the verification of access rights, particularly the MAC address declaration to the second device, and another IP address for communications with the devices of the local area network or of external networks.

This solution also ensures secure connections (including access control to a WLAN network) without requiring a layer 2 security function (L2 of OSI model).

In a particular embodiment, the method comprises the reception, by the first device, of a request to generate at least one new MAC address capable of being associated with the first interface of the first device.

Such a request can come from the second device or from another device, for example a remote server.

According to a first example, the first device can contact the remote server relating to a given service, receive from the remote server a request to generate at least one new MAC address, and then implement the steps for associating its first interface with a new MAC address as described above.

According to a second example, the first device can have a list of at least one candidate MAC address that the first device plans to use to communicate with the second device (“LIST_MAC_ADDRESS”), and associate its first interface with a candidate address from the list following the reception of the request to generate at least one new MAC address.

The reception of the request to generate at least one new MAC address can therefore be implemented before or after at least one candidate MAC address is obtained.

The invention also relates to a method for communication between the first device and the second device, implemented by the second device, and comprising:
establishing a first secure connection between the first device and the second device, via a first communication interface of the first device,
receiving, using the first secure connection, a message comprising at least one encrypted MAC address, associated or capable of being associated with the first interface and used to communicate with or via the second device or an intermediate device located on a communication path between the first device and the second device,
validating said at least one MAC address.

As indicated above, the first device can thus declare to the second device the current MAC address it uses to communicate with or via the second device, or at least one candidate MAC address it wants to use to communicate with or via the second device.

The second device can in particular validate said at least one MAC address; more particularly, it can verify the absence of conflict in the use of said at least one MAC address, and possibly verify a security context shared between the first device and the second device.

In particular, as also indicated above, the second device can verify that the source MAC address of the message, conveyed in clear text in the message transmitted via the first secure connection, conforms to the encrypted current MAC address and as declared in the message, which makes it possible to detect any manipulation of the information conveyed in clear text in the first connection.

According to a particular embodiment, said validation implements the verification of the absence of conflict in the use of said at least one MAC address and, if no conflict is detected, the transmission to the first device of a message verifying the absence of use conflict. For example, when the QUIC protocol is used for the first secure connection, the second device can transmit a QUIC frame, for example referred to as “MAC_IN_USE”, to the first device if the current MAC address or the candidate MAC address is not available (for example because it is already being used by another device of the network or because it has been used recently). Conversely, if the MAC address is available, the second device can transmit an acknowledgement message (“ACK”) to the first device in response to the message comprising the encrypted MAC address.

According to a particular embodiment, said validation implements the verification of a security context shared between the first device and the second device, associated with said at least one MAC address.

For example, such a security context belongs to the group comprising:
a security key known to the first device and the second device,
an item of information representative of an authentication certificate of the first device, such as for example:
   the authentication certificate itself,
   an identifier of an authentication certificate of the first device,
   an authentication certificate digest of the first device, etc.

Thus, the first device can transmit, in addition to said at least one MAC address associated or capable of being associated with the first interface and used to communicate with or via the second device or the intermediate device, a security context, that the second device can verify to confirm the identity of the first device.

In a particular embodiment, the second device implements the creation, or the update, of at least one filtering rule associated with the first device, with said at least one MAC address.

A filtering rule can thus be associated with at least one MAC address and possibly a security context.

A filtering rule can be associated with an action such as accepting or rejecting traffic (including traffic corresponding to network connection requests) from and/or to the first device, identified by said MAC address.

A filtering rule can be active or not. By default, it is active if it is associated with a MAC address.

A validity period can possibly be configured for a filtering rule.

According to a particular embodiment, the method implements a preliminary phase of configuring the filtering rules. Such a configuration phase can, for example, be implemented by an administrator via an administration interface and/or using a configuration protocol.

In a particular embodiment, the method implemented by the second device comprises transmitting, using the first secure connection, a security key generated by the second device.

As previously indicated, such a key can be used permanently or renewed dynamically. In the latter case, the security key can be generated randomly, periodically, following a triggering event, etc. Such a key can, for example, be transmitted in a “MAC_TOKEN” QUIC frame.

In a particular embodiment, a temporary IP address being allocated to the first device for transmitting the message, the method implements an allocation of a new IP address to the first device after said validation of said at least one MAC address.

As previously indicated, the second device thus allocates a new IP address to the first device only once said at least one MAC address has been validated by the second device and, more generally, when the service access rules have been validated (for example, taking into account access time slots for parental control purposes). In a particular embodiment, the second device transmits to the first device a proposal for at least one new MAC address capable of being associated with the first interface of the first device, using the first secure connection between the first device and the second device.

For example, such a proposal can be transmitted following the detection of a conflict with the current MAC address or an encrypted candidate MAC address, as declared by the first device in the message. If the first secure connection is based on the QUIC protocol, such a proposal can be transmitted in the “MAC_IN_USE” QUIC frame.

In a particular embodiment, the first device and the second device can exchange messages to confirm that they are capable of implementing the invention, according to at least one embodiment.

For example, the first device implements the transmission of a first parameter signalling to the second device that the first device is capable of transmitting a message comprising at least one encrypted MAC address, associated or capable of being associated with the first interface and used to communicate with or via the second device or the intermediate device. In other words, this first parameter signals to the second device that the first device is capable of changing its current MAC address (either spontaneously or upon receipt of a MAC address renewal request), transmitting at least one candidate MAC address, etc.

The second device also implements, for example upon receipt of this first parameter, the transmission of a second parameter signalling to the first device that the second device is capable of receiving the message comprising at least one encrypted MAC address, associated or capable of being associated with the first interface and used to communicate with or via the second device or the intermediate device.

For example, such parameters are QUIC transport parameters, referred to herein as “mac-update”, and set to 1 to indicate that the device transmitting the QUIC message comprising such a parameter supports the method according to the invention.

The exchange of such parameters can be implemented before the transmission, by the first device, of the message comprising at least one encrypted MAC address.

In other embodiments, the invention relates to corresponding first device and second device.

One embodiment of the invention also aims to protect one or more computer programs comprising instructions suitable for implementing the communication method according to at least one embodiment of the invention as described above, when this or these program(s) is/are executed by a processor, as well as at least one computer-readable information medium comprising instructions of at least one computer program as mentioned above.

### 4. LIST OF FIGURES

Other characteristics and advantages of the invention will emerge more clearly upon reading the following description of a particular embodiment, provided as a simple illustrative non-restrictive example, and the annexed drawings, wherein:

FIG. 1 shows an example of network architecture;

FIG. 2 illustrates the main steps of a communication method according to at least one embodiment of the invention;

FIG. 3 illustrates the exchange of parameters to verify the compatibility of two devices according to one embodiment of the invention;

FIGS. 4, 5 and 6 illustrate examples of messages exchanged between a first device and a second device to declare MAC addresses according to one embodiment of the invention;

FIG. 7 shows a particular embodiment based on the use of a temporary IP address for connection to the network;

FIG. 8 shows the simplified structure of a first device, respectively second device, according to a particular embodiment.

### 5. DESCRIPTION OF AN EMBODIMENT OF THE INVENTION

### 5.1 General Principle

The general principle of the invention is based on the use of a secure connection between a first device and a second device, allowing the first device to manage the current MAC address(es) it uses to communicate with or via the second device, or at least one candidate MAC address it plans to use to communicate with or via the second device. In this way, the second device can validate the current MAC address(es) or a list of at least one candidate MAC address, that is verify in particular the absence of conflict in the use of the current or candidate MAC addresses, and possibly verify a security context shared between the first device and the second device. The first device can thus renew its current MAC address(es) by using at least one candidate MAC address previously validated by the second device, upon decision of the first device or upon receipt of a MAC address renewal request from the second device or another device, for example a remote server.

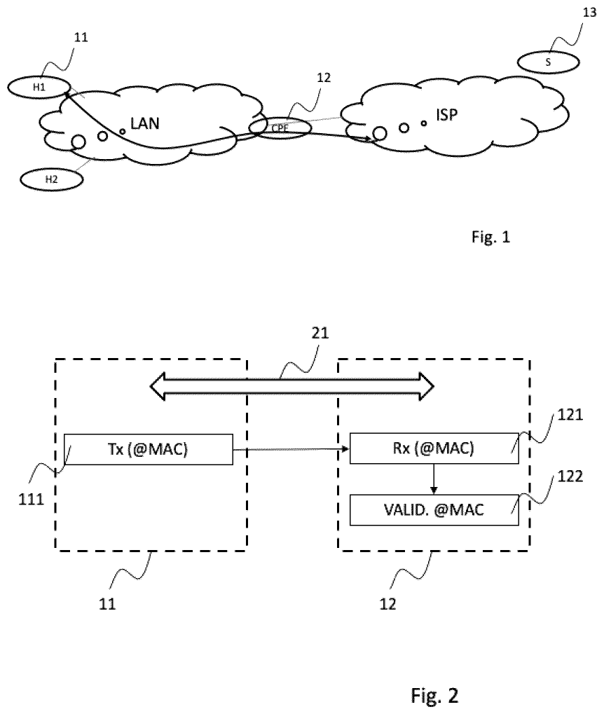

By way of example, as illustrated in FIG. 1, a local area network LAN comprising at least a first device 11, for example a terminal H11, and a second device 12, for example a home gateway, also called HG or CPE. The first device 11 can in particular be in communication with a remote server S13, via the second device 12.

It is recalled that a home gateway is typically used as an interface between the local area network of the user and the network of an operator with which the user has subscribed to a service offer (Internet Service Provider, ISP). It is therefore a device for access to the network of an operator through which all the traffic characteristic of the various services subscribed to by the user transits, and which also supports a set of services provided locally to the terminals (for example, FTP (File Transfer Protocol) service, NFS (Network File System) service, media server, etc.).

As previously indicated, other network architectures or other types of devices can be used in the context of the invention.

FIG. 2 illustrates the main steps implemented by the first device 11 and the second device 12 to implement the communication method according to one embodiment of the invention.

During a first step 21, a first secure connection is established between the first device 11 and the second device 12, via a first communication interface of the first device 11. For example, such a secure connection uses a QUIC, CoAP/DTLS, PCP, etc. protocol. The establishment of such a secure connection being conventional, it is not described in more detail here.

During a subsequent step 111, the first device 11 transmits a message to the second device 12, using the first secure connection. Such a message comprises at least one encrypted MAC address, associated or capable of being associated with the first interface and used to communicate with or via the second device or an intermediate device located on a communication path between the first device and the second device.

The second device 12 can thus receive such a message during a step 121, and validate the MAC address(es) received during a step 122.

### 5.2 Embodiment

A particular embodiment, according to which the first device 11 can change MAC address while benefiting from a continuity of service (that is, the device can continue to provide or access its services even in case of MAC address change) is presented below. To do this, filtering rules associated with MAC addresses are configured in the second device 12 (CPE). Such rules can be used to accept traffic from/to a device having an interface configured with a given MAC address (if this MAC address is associated with an action of type “authorisation to send traffic with this MAC address”, or belongs to an “accept-list”) or to reject traffic from/to a given MAC address (if this MAC address is associated with an action of type “rejection of traffic using this MAC address”, or belongs to a “discard-list”).

### 5.2.1 Configuring the Rules

Certain rules can be configured or preconfigured in the second device, for example via an administration interface and/or using a configuration protocol, such as for example PCP, NETCONF, RESTCONF, etc. They can in particular be updated when a new MAC address is associated with an interface of the first device.

It should be noted that rule configuration does not assume that the device concerned by the rule is connected to the local area network at the time of configuration.

Examples of filtering rules are described below. It is considered for example that a filtering rule comprises several parameters:
a “MAC address” parameter,
an “action” parameter, for example authorisation (“accept”) or rejection (“discard”) of the traffic,
a “rule status” parameter, for example, active or candidate rule,
a “security context” parameter,
a “rule validity” parameter, for example, permanent validity, validity until a certain date, etc.

The following table shows an example of a filtering rule table that can be maintained by the second device 12. Of course, some of these parameters can be optional.

| Rule | MAC | | | Security | |
|---|---|---|---|---|---|
| identifier | address | Action | State | context | Validity |
| 1 | Empty | Authorisation | Candidate | Context_1 | Permanent |
| 2 | @MAC2 | Rejection | Active | Context_2 | 15 Jun. 2022 |
| 3 | @MAC3 | Rejection | Active | Context_3 | 1 Feb. 2022 |
| . . . | | | | | |

Thus, it is considered for example that if at least one MAC address is associated with a rule, then the filtering rule is activated (rule status set to “Active”), that is, the rule is taken into account when the second device processes traffic to or from this MAC address (for example, rejection of traffic to or from the address @MAC2). However, if no MAC address is associated with a rule, then the rule is identified with a state set to “Candidate”).

A rule can switch to the “Active” state when at least one MAC address is associated with the rule, as described below.

A rule can also be associated with a security context between the first device (identified by the MAC address) and the second device (maintaining the filtering rules). The security context can be:
a shared security key known to the first device and the second device,
an item of information representative of an authentication certificate of the first device, such as:
   an authentication certificate of the first device;
   an identifier of an authentication certificate of the first device, for example a PKIX certificate identifier (for example, a domain name or an IP address). By way of example, domain name authentication mechanisms can be implemented, such as ACME (“Automatic Certificate Management Environment”, as described in document RFC 8555 dated March 2019),
   an authentication certificate digest of the first device whose production is based on a hash algorithm such as SHA2-256 (“Secure Hash Algorithm v2”, 256 bits). This digest can be used, for example, to validate a request to modify a MAC address filtering rule.

A rule can be instantiated and activated when connecting a device to the local area network and/or following the reception by the second device 12 of a consent message from an administrator of the local area network.

A default rule can be configured on the second device 12 to control the processing of packets that do not match any of the explicitly declared MAC address filtering rules. For example, this default rule can consist in prohibiting access to the local area network or Internet connectivity for all undeclared MAC addresses.

A rule can also be associated with a validity period, for example permanent, or indicate an expiry date for the rule. A rule can be automatically deleted from the table at this date.

The table can also include a configuration parameter that allows a token to be shared with a device that connects to a network for the first time. In particular, such a key can be used to initialise the association between the first device and the second device (e.g. during a first association with the network). It can then be replaced by another security key, that can be transmitted by the second device in the “MAC_TOKEN” QUIC frame as described hereafter.

### 5.2.2 Connecting a Device to the Network

It is considered that the first device 11 wants to connect to the network LAN.

To do this, the first device can use its default MAC address (current MAC address) or generate a new MAC address to connect to the network LAN. This MAC address can be used to generate service traffic at the time of connection (for example, an ARP broadcast message or an NS (Neighbor Solicitation) message).

It should be noted that the first device can communicate with other devices of the network using one or more communication interfaces, for example a WLAN interface, an Ethernet interface, etc.

The first device 11 detects its default gateway, which may be different for each of its interfaces. According to the example considered, the default gateway is the second device, i.e. the CPE connected to the same local area network as the first device. Thus, the second device 12 (CPE) is the default gateway for the first interface of the first device 11.

The identity of such a gateway can be communicated by a DHCP OFFER message, typically used to assign an IP address to a device and inform it in particular about its default gateway, the MTU (Maximum Transmission Unit) value, etc.

It should be noted that the default gateway can be connected to the same network LAN as the first device or be located several IP hops away from the first device, for example in the case where the local area network is a routed network that comprises a router in addition to the CPE. In this case, the CPE can centralise the access control procedure and in particular the MAC address management and update procedure, and the additional router is an “intermediate device” in the sense of the invention.

As shown in FIG. 2, the first device then establishes a first secure connection with the second device 12 (CPE), which is the default gateway for the first interface of the first device 11. To do this, the first device can use as destination address the IP address of the default gateway, discovered for example from the DHCP_OFFER message. If no IP address to reach the default gateway is acquired by the first device, it uses a dedicated anycast address such as 192.0.0.9/32 or 2001:1::1/128, as proposed in document RFC 6890 (April 2013).

It is considered hereafter that the first secure connection uses a QUIC/UDP protocol. As already indicated, in other embodiments, the first secure connection can use the CoAP/DTLS protocol or any other protocol establishing a secure connection.

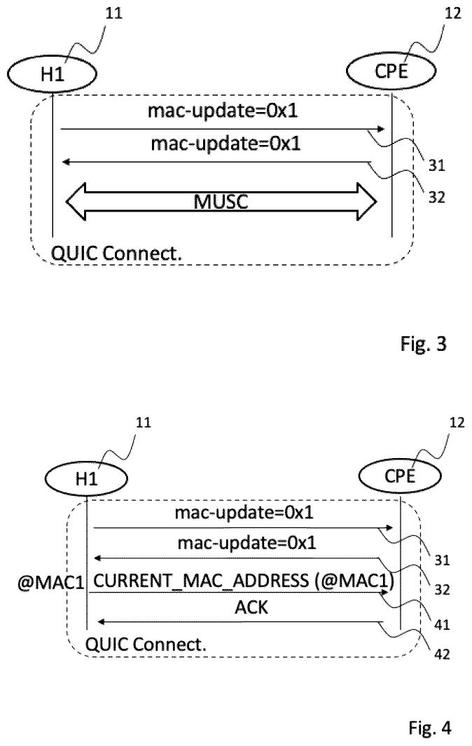

According to a particular embodiment, illustrated in FIG. 3, the first device uses a new QUIC transport parameter (as provided for in section 7.4.2 of document RFC 9000, May 2021), referred to herein as “mac-update”, to signal to the second device that it supports the MUSC procedure, which ensures a continuity of service even when MAC addresses are generated randomly (“randomisation”). In other words, the first device 11 implements the transmission 31 of a first parameter signalling to the second device 12 that the first device 11 is capable of changing its current MAC address (either spontaneously or upon receipt of a MAC address renewal request), transmitting at least one candidate MAC address, etc. If the second device also supports the MUSC procedure, it can respond using the new “mac-update” QUIC transport parameter. In other words, the second device 12 implements the transmission 32 of a second parameter signalling to the first device 11 that the second device 12 is capable of processing the MAC address(es) received from the first device 11.

These first and second parameters are for example set to “1” (mac-update=0x1) to indicate that the MUSC procedure is supported. It is assumed in the following that the first device 11 and the second device 12 support the MUSC procedure.

In a particular embodiment, the second device 12 sends to the first device 11, that initiated the establishment of a first secure QUIC connection, a frame comprising a security key shared by the two devices. Such a frame is transmitted using the first secure connection (QUIC frame according to the example considered). For example, such a frame is referred to as “MAC_TOKEN”. The security key is preferably generated randomly by the second device. When the first device subsequently wants to communicate with the second device, it must, in the embodiment described here, present the security key (for example by transmitting it with the encrypted MAC address in a QUIC frame), which enables the second device to verify the identity of the first device. The security key is therefore an example of a security context that can be associated with a rule.

The second device can also renew its security key (for example, periodically) and transmit the new key to the first device in a new “MAC_TOKEN” frame, using the first secure connection.

As shown in FIG. 2, once the first secure connection has been established, the first device can transmit a message to the second device using the first secure connection. Such a message comprises at least one encrypted MAC address, associated or capable of being associated with the first interface of the first device and used to communicate with or via the second device (CPE) or an intermediate device (router) located on a communication path between the first device and the second device.

Different types of messages can be sent from the first device 11 to the second device 12 (step 111 of FIG. 2).

According to a first example, the message corresponds to at least one QUIC frame describing the current MAC address that the first device uses to communicate with or via the second device, referred to herein as “CURRENT_MAC_ADDRESS” for example. Such a current MAC address is therefore already assigned to the first interface used to contact the second device.

The insertion of the current MAC address in the new frame, and therefore its encryption related to the use of the QUIC secure connection, enables the second device to compare information carried in the encrypted part of the message (for example, the current MAC address) with information conveyed in clear text in the QUIC connection (for example, the source MAC address) and to detect any manipulation of the information conveyed in clear text.

Inserting the current MAC address in the new frame also allows the current MAC address to be communicated to the second device even if it is not directly connected to the first device (in the case of an intermediate device such as a router, for example).

FIG. 4 shows an example of messages exchanged between the first device 11 and the second device 12. Once the first secure connection has been established, the first device 11 and the second device 12 can exchange messages 31, 32 to verify that they both support the MUSC procedure. Several “CURRENT_MAC_ADDRESS” frames can be present in a message.

If this is the case, the first device 11 can send a message comprising at least one “CURRENT_MAC_ADDRESS” frame 41 on the first secure connection, from its current MAC address @MAC1 assigned to the first interface of the first device 11 to communicate with or via the second device 12. According to this embodiment, this message comprises the encrypted current address @MAC1.

The second device 12 can in particular perform a step of validating the current MAC address @MAC1.

For example, the second device 12 can verify if the source MAC address @MAC1 and the encrypted current MAC address @MAC1 are identical.

The second device 12 can also implement a verification of the absence of conflict in the use of the current MAC address @MAC1. Indeed, the second device 12 is typically a device for accessing the network of an operator, through which all the traffic characteristic of the various services subscribed to by the user transits. It therefore has knowledge of the different MAC addresses used in the network. For example, if no use conflict is detected with the current MAC address @MAC1, the second device 12 transmits (42) an acknowledgement message (ACK) to the first device 11.

The second device 12 can also implement a verification of a security context between the first device 11 and the second device 12. For example, the second device 12 verifies the reception of a “MAC_TOKEN” frame comprising a security key to authenticate the first device 11 before transmitting the acknowledgement message (ACK) to the first device 11.

The second device 12 can then extract the current MAC address @MAC1 from the message carrying at least one “CURRENT_MAC_ADDRESS” frame 41 and update the filtering rule(s) associated with the first device 11.

| Rule | MAC | | | Security | |
|---|---|---|---|---|---|
| identifier | address | Action | State | context | Validity |
| 1 | @MAC1 | Authorisation | Active | Context_1 | Permanent |
| 2 | @MAC2 | Rejection | Active | Context_2 | 15 Jun. 2022 |
| 3 | @MAC3 | Rejection | Active | Context_3 | 3 May 2022 |
| . . . | | | | | |

According to a particular embodiment, the second device 12 can accept or reject the first secure connection depending on the security context(s) it maintains with the first device 11, or according to a consent that the second device 12 requests from an administrator.

If no security context is present, or if the administrator's consent has not been obtained, the secure connection can be rejected by the second device 12. A default rule according to which all MAC addresses are filtered can then be applied.

If the first secure connection is established, the first device 11 can communicate with devices connected to the local area network and with devices connected to the Internet network, under the filtering rules set up by the second device 12.

A first example according to which the message transmitted via the first secure connection corresponds to a “CURRENT_MAC_ADDRESS” QUIC frame has been described above.

According to a second example, the first device 11 can generate at least one new MAC address (for example, d6:e2:d6:33:bb:61), and transmit this new MAC address (d6:e2:d6:33:bb:61) in encrypted form in a transmitted message that uses the first secure connection. The second device 12 can then update the filtering rules, as described above.

In particular, the filtering rules can be updated before or after the MAC address is changed, in a preventive or corrective mode.

According to a third example, the first device 11 can prepare the MAC address migration by first indicating to the second device 12 at least one MAC address it plans to use, called candidate MAC address.

According to this third example, the message sent from the first device 11 to the second device 12, via the first secure connection (step 111 of FIG. 2), corresponds to a QUIC frame, referred to herein as “LIST_MAC_ADDRESSES” for example, comprising at least one encrypted candidate MAC address that the first device plans to use to communicate with or via the second device (for example, a5:c7:ef:82:58:e9, e1:44:50:32:3c:72, ee:3c:50:18:7e:44). At this stage, none of these candidate MAC addresses is associated with the first interface of the first device 11.

In particular, before associating a candidate MAC address with an interface of the first device 11, the first device 11 can verify with the second device 12 that the candidate MAC address is available. In particular, this avoids a conflict with the MAC addresses used by other devices connected to the same network and avoids impacting the service access delay caused by a MAC address change.

Thus, according to a fourth example, the message sent by the first device 11 to the second device 12, via the first secure connection (step 111 of FIG. 2), corresponds to a QUIC frame, referred to herein as “CANDIDATE_MAC_ADDRESS” for example, comprising at least one encrypted candidate address.

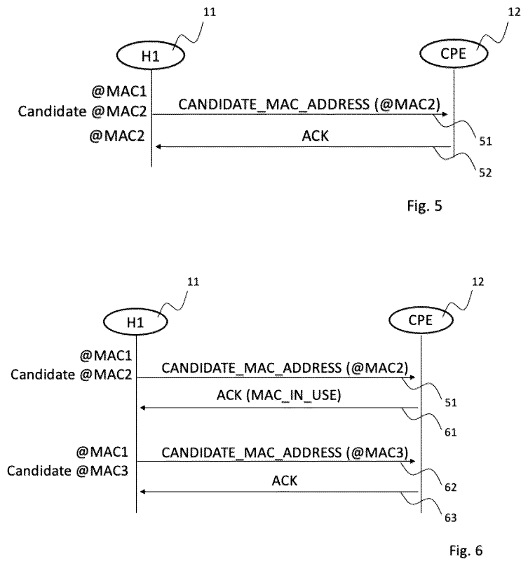

As illustrated in FIG. 5, the first device 11 that wants to change its current MAC address @MAC1 can use the “CANDIDATE_MAC_ADDRESS” frame 51, transmitted via the first secure connection, to ask the second device 12 if the candidate MAC address @MAC2 (for example, @MAC2-a5:c7:ef:82:58:e9) is already used by a device of the network.

If the candidate MAC address @MAC2 is available, the second device 12 can return an acknowledgement message ACK 52 via the first secure connection, and the candidate MAC address @MAC2 (a5:07:ef:82:58:e9) can be assigned to the first interface of the first device 11. If the candidate MAC address @MAC2 is not available, as shown in FIG. 6, the second device 12 can return a message, referred to herein as “MAC_IN_USE” 61 for example, via the first secure connection.

The first device 11 can generate a new candidate MAC address @MAC3 (for example, @MAC3=3f:e1:48:1a:13:6c) and use the “CANDIDATE_MAC_ADDRESS” frame 62, transmitted via the first secure connection, to ask the second device 12 if the candidate MAC address @MAC3 is already used by a device of the network.

If the candidate MAC address @MAC3 is available, the second device 12 can return an acknowledgement message ACK 63 via the first secure connection, and the candidate MAC address @MAC3 (3f:e1:48:1a:13:6c) can be assigned to the first interface of the first device 11. In a particular embodiment, the second device 12 can transmit to the first device 11 a MAC address proposal to be used for the first interface of the first device 11, for example in a dedicated field of the “MAC_IN_USE” frame. This field is referred to herein as “SUGGESTED_MAC”. The frame can also include a recommendation for the validity period of the MAC addresses used in this network. The first device 11 can accept or reject the MAC address proposal from the second device 12.

In a particular embodiment, if no conflict has been detected, the first device 11 can then send the “CURRENT_MAC_ADDRESS” frame or the “LIST_MAC_ADDRESSES” frame depending on whether or not the candidate address is used.

Thus, in one embodiment, several messages comprising encrypted MAC addresses can be transmitted using the first secure connection.

A particular embodiment enabling in particular to verify that the identity of the first device 11 has not been spoofed is described below.

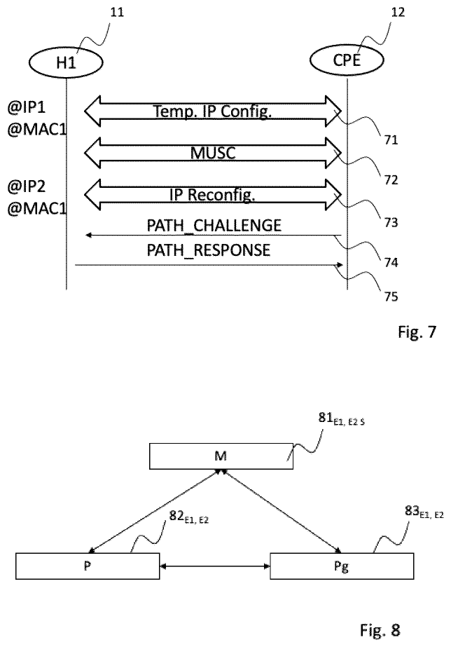

According to this embodiment, illustrated in FIG. 7, a temporary IP address @IP1 is allocated to the first device 11. Such a temporary IP address is used to configure information local to the first device 11 during a configuration step 71 (identification of the default gateway associated with the first interface of the first device in particular). Such a temporary IP address can thus be used to establish a communication with the second device 12 (i.e. the default gateway), but not with the other devices of the network or of an external network.

A first secure connection can then be established via the first interface of the first device 11 and the second device 12, and messages comprising encrypted MAC addresses such as messages comprising at least one “CURRENT_MAC_ADDRESS”, “CANDIDATE_MAC_ADDRESS”, or “LIST_MAC_ADDRESS” frame, can be transmitted from the first device 11 to the second device 12 using the first secure connection, during the MUSC procedure 72.

When the configuration of this information is confirmed by the first device 11 to the second device 12 (acknowledgement procedure within the QUIC communication, corresponding for example to the messages ACK 42 in FIG. 4, or ACK 52 in FIG. 5, or ACK 63 in FIG. 6), then an IP address reconfiguration procedure 73 can be triggered by the second device 12. Such an IP address reconfiguration procedure 73 enables the first device 11 to be assigned an IP address extracted from another range (@IP2 according to FIG. 7), which enables the first device 11 to be reached on the network.

In particular, in order to avoid, or at least reduce the risk that devices spoof the MAC address of other devices of the local area network in order to obtain communication privileges (that is, benefit from their communication capabilities/authorisations) in particular, the second device 12 can generate a QUIC PATH_CHALLENGE message 74 to the source IP address of a received packet (@IP2), upon receipt of an IP packet with a source address (@IP2) different from that known to the second device 12 (@IP1) for the associated MAC address (@MAC1). The first device 11 must return a valid response PATH_RESPONSE 75 to the second device 12, which enables the second device 12 to validate the new IP address (@IP2) and grant the access privileges associated with said MAC address (@MAC1) used by the first device 11 that used the new IP address (@IP2) to communicate (with the second device 12 or via the second device 12).

Another variant implementation is based on establishing a first secure connection using the PCP protocol, as described in document RFC 7652 of September 2015. A new message comprising at least one encrypted MAC address, referred to as MAC_FILTER message for example, is transmitted from the first device to the second device. The encrypted MAC address corresponds to a new MAC address associated or capable of being associated with a first interface of the first device and used to communicate with or via the second device or an intermediate device located on a communication path between the first device and the second device.

The presence of the MAC_FILTER message indicates that the new MAC address can be used to instantiate an entry in a MAP or PEER request. Upon receipt of a MAC_FILTER message transmitted using the PCP protocol, the second device 12 calculates the digest of the certificate presented by the first device 11 using the same algorithm (for example a SHA2-256 algorithm). If the digest thus obtained corresponds to a trusted digest maintained by the second device 12, the latter creates or updates a MAC address filtering rule with the new MAC address.

In short, thanks to the MUSC procedure, a first device can renew its MAC address without impacting the services (for example, parental control) and filtering rules set up within a network. In particular, the coordination of the first device with the second device to update a filtering rule using a secure connection is advantageous because it enables MAC address spoofing to be detected. It should be noted that the procedure described above can be implemented for one or more interfaces of the first device, and for one or more devices of the network. Different second devices (gateways, routers, etc.) can notably be contacted via the different interfaces of the same first device (for example, a WLAN interface, an Ethernet interface, etc.).

In particular, considering several second devices contacted via different interfaces, security identifiers per second device can be used to condition the establishment of the secure connection (that is, these identifiers are used to confirm that the first device does indeed contact, via its communication interface, the second device authorised to establish a secure connection with the first device via this interface).

### 5.3 Corresponding Devices

Finally, a description is given, in relation to FIG. 8, of the simplified structures of a first device E1 and a second device E2 according to at least one embodiment of the invention.

A first device E1 (respectively a second device E2) according to one embodiment of the invention comprises a memory 81_{E1} (respectively 81_{E2}), a processing unit 82_{E1} (respectively 82_{E2}), equipped for example with a programmable computing machine or a dedicated computing machine, for example a processor P, and controlled by the computer program 83_{E1} (respectively 83_{E2}), implementing steps of the communication method according to at least one embodiment of the invention.

At initialisation, the code instructions of the computer program 83_{E1} (respectively 83_{E2}) are for example loaded into a RAM memory before being executed by the processor of the processing unit 82_{E1} (respectively 82_{E2}).

The processor of the processing unit 82_{E1} of the first device implements steps of the communication method previously described, according to the instructions of the computer program 83_{E1}, to:
establish a first secure connection with the second device E2, via a first communication interface of the first device,
transmit, using the first secure connection, a message comprising at least one encrypted MAC address, associated or capable of being associated with the first interface and used to communicate with or via the second device or an intermediate device located on a communication path between said first device and said second device.

The processor of the processing unit 82_{E2} of the second device implements steps of the communication method previously described, according to the instructions of the computer program 83_{E2}, to:
establish a first secure connection with the first device E1, via a first communication interface of the first device,
receive, using the first secure connection, a message comprising at least one encrypted MAC address, associated or capable of being associated with said first interface and used to communicate with or via said second device or an intermediate device located on a communication path between said first device and said second device,
validate said at least one MAC address.

1. A method for communication between a first device and a second device, implemented by said first device, comprising:
establishing a first secure connection between said first device and said second device, via a first communication interface of said first device, said first secure connection being based on a secure transport protocol or on a secure application protocol; and
transmitting, using said first secure connection, a message comprising at least one encrypted Media Access Control (MAC) address, associated or capable of being associated with said first interface and used to communicate with or via said second device or an intermediate device located on a communication path between said first device and said second device.

2. The method according to claim 1, wherein said at least one MAC address comprises a current MAC address associated with said first interface and used to communicate with or via said second device or said intermediate device, and said first device implements receiving, using said first secure connection, a message verifying absence of conflict in a use of said current MAC address.

3. The method according to claim 1, wherein said at least one MAC address comprises at least one candidate MAC address capable of being associated with said first interface and used to communicate with or via said second device or said intermediate device, and said first device implements receiving, using said first secure connection, of a message verifying absence of conflict in a use of at least one of said candidate MAC addresses, and in absence of conflict, an association of said first interface with a verified candidate MAC address.

4. The method according to claim 1, wherein the method comprises receiving, using said first secure connection, a security key generated by said second device.

5. The method according to claim 1, wherein a temporary IP address is allocated to said first device for transmitting said message, and said method implements an allocation of a new IP address to said first device after validation, by said second device, of said at least one MAC address.

6. The method according to claim 1, wherein the method comprises receiving a request to generate at least one new MAC address capable of being associated with said first interface.

7. A method for communication between a first device and a second device, implemented by said second device, comprising:
establishing a first secure connection between said first device and said second device, via a first communication interface of said first device, said first secure connection being based on a secure transport protocol or on a secure application protocol;
receiving, using said first secure connection, a message comprising at least one encrypted Media Access Control (MAC) address, associated or capable of being associated with said first interface and used to communicate with or via said second device or an intermediate device located on a communication path between said first device and said second device; and
validating said at least one MAC address.

8. The method according to claim 7, wherein said validation implements verification of an absence of conflict in the use of said at least one MAC address and, if no conflict is detected, transmitting to said first device of a message verifying the absence of use conflict.

9. The method according to claim 1, wherein said validation implements a verification of a security context between said first device and said second device, associated with said at least one MAC address.

10. The method according to claim 7, wherein the method comprises creating or updating at least one filtering rule associated with said first device, with said at least one MAC address.

11. The method according to claim 7, wherin the method comprises transmitting to said first device a security key, using said first secure connection between said first device and said second device.

12. The method according to claim 7, wherein a temporary IP address being allocated to said first device for transmitting said message, said method implements an allocation of a new IP address to said first device after said validation.

13. The method according to claim 7, wherein the method comprises transmitting a proposal of at least one new MAC address capable of being associated with said first interface of said first device, using said first secure connection between said first device and said second device.

14. A first device, comprising at least one processor configured to:
establish a first secure connection with a second device, via a first communication interface of said first device, said first secure connection being based on a secure transport protocol or on a secure application protocol; and
transmit, using said first secure connection, a message comprising at least one encrypted Media Access Control (MAC) address, associated or capable of being associated with said first interface and used to communicate with or via said second device or an intermediate device located on a communication path between said first device and said second device.

15. A second device, comprising at least one processor configured to:
establish a first secure connection with a first device, via a first communication interface of said first device, said first secure connection being based on a secure transport protocol or on a secure application protocol,
receive, using said first secure connection, a message comprising at least one encrypted Media Access Control (MAC) address, associated or capable of being associated with said first interface and used to communicate with or via said second device or an intermediate device located on a communication path between said first device and said second device; and
validate said at least one MAC address.
